(19) United States
(12) Patent Application Publication
(10) Pub. No.: US 2008/0252281 A1
(43) Pub. Date: Oct. 16, 2008

(54) Switching power supply circuit having soft start circuit

(75) Inventors: Huai-Zhu Yan, Shenzhen (CN); Tong Zhou, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 11/906,451

(22) Filed: Oct. 1, 2007

(30) Foreign Application Priority Data
Sep. 29, 2006 (TW) 95136320

(51) Int. Cl. G05F 1/00

(52) U.S. Cl. 323/288

(57) ABSTRACT

An exemplary switching power supply circuit includes at least a power input terminal, a power control chip, and a soft start circuit. The power input terminal is configured for receiving an operating voltage applied to the switching power supply circuit, and the power control chip is configured for modulating a pulse width of an output current of an optical coupler in the soft start circuit to gain a pulse width voltage of the switching power supply circuit. The soft start circuit includes a first resistor, a second resistor, a capacitor, and a transistor performing an amplifying function.

### FIELD OF THE INVENTION

The present invention relates to an improved switching power supply circuit having a soft start circuit that occupies a small volume.

### GENERAL BACKGROUND

Switching power supplies are widely used in coordination with various portable and automated electronic devices and instruments. In addition to meeting the requirements of low weight, small size and low power consumption, these switching power supplies need to overcome or at least mitigate other intrinsic problems. For example, at the moment of switching, excessive current and heat impact can occur in various components or elements within a switching power supply circuit where charging or discharging takes place. The excessive current and heat can disable main circuit elements and lower the reliability of the switching power supply circuit. Ordinarily, the switching power supply circuit needs a soft start circuit such as a snubber circuit, to prevent excessive current rushes from occurring and thereby protect main circuit elements.

As shown in FIG. 2, a typical switching power supply circuit 10 includes a first input terminal 11, a second input terminal 12, a voltage-dividing unit 13, a voltage-stabilizing unit 14, a snubber circuit 15, a power control chip 16, and a power supply output terminal 17. The first input terminal 11 and the second input terminal 12 supply the switching power supply circuit 10 with operating voltages of +5V and +12V, respectively. The voltage-dividing unit 13 outputs a divided voltage to the voltage-stabilizing unit 14, and the divided voltage serves as a voltage-stabilizing reference for the voltage-stabilizing unit 14. When a current flow of the snubber circuit 15 is so small that an output pulse width voltage of the switching power supply circuit 10 rises beyond a predetermined threshold level, the voltage-stabilizing unit 14 modulates the current flow of the snubber circuit 15 such that the output pulse width voltage does not exceed the voltage-stabilizing reference.

The +5V operating voltage is supplied to the snubber circuit 15 and the power control chip 16, and an output voltage at the power supply output terminal 17 is supplied to an external load circuit (not shown) via a transformer (not shown).

The voltage-dividing unit 13 includes a first resistor 131, a second resistor 132, and a third resistor 133. The three resistors 131, 132, 133 electrically join together at a voltage-dividing node 134. The +5V operating voltage at the first input terminal 11 is applied across the first resistor 131 and the third resistor 133 and then grounded, while the +12V operating voltage at the second input terminal 12 is applied across the second resistor 132 and the third resistor 133 and then grounded. In this way, a voltage at the voltage-dividing node 134 can be calculated according to Kirchhoff's Law, and the calculated voltage serves as the voltage-stabilizing reference for the voltage-stabilizing unit 14.

The snubber circuit 15 includes a fourth resistor 151, a fifth resistor 152, a diode 153, a capacitor 154, and an optical coupler 155. The +5V operating voltage at the first input terminal 11 is grounded via two paths. In one path, the fourth resistor 151, the optical coupler 155, the diode 153, and the capacitor 154 are included; while in the other path, the fifth resistor 152 and the capacitor 154 are included. A so-called IN4148 type diode is ordinarily chosen to be the diode 153.

The optical coupler 155 includes a transistor 156 and a light emitting diode 157. The transistor 156 includes a base electrode, an emitter electrode, and a collector electrode. The transistor 156 conducts current by way of the collector electrode being supplied with an operate voltage Vss via a current-limiting resistor 158, and the base electrode sensing photons emitted from the light emitting diode 157. Thereby, the power control chip 16 connected to the emitter electrode receives an output current of the optical coupler 155. The power control chip 16 modulates a pulse width of the output current with a sawtooth pulse, such that a pulse width voltage obtained at the power supply output terminal 17 is in inverse proportion to the output current.

The voltage-stabilizing unit 14 includes a three-terminal shunt regulator 141 and an RC (resistance-capacitance) series filtering circuit. A typical three-terminal shunt regulator 141 includes an anode 1411, a cathode 1412, and a reference terminal 1413. The anode 1411 is grounded, while the cathode 1412 and the reference terminal 1413 are connected to two terminals of the RC series filtering circuit respectively. The reference terminal 1413 is also connected with the voltage-dividing node 134. A so-called TL431 type shunt regulator is usually chosen to be the three-terminal shunt regulator 141.

When a current flow I of the optical coupler 155 is so small that the output pulse width voltage at the power supply output terminal 17 is excessive, the three-terminal shunt regulator 141 outputs an adjusting voltage at the cathode 1412. The adjusting voltage is then input to the cathode terminal of the light emitting diode 157, and the current flow I is accordingly adjusted such that the output pulse width voltage of the switching power supply circuit 10 does not exceed the voltage-stabilizing reference.

When the switching power supply circuit 10 starts, the +5V operating voltage at the first input terminal 11 charges the capacitor 154 via the path including the fourth resistor 151, the optical coupler 155, and the diode 153, and via the other path including the fifth resistor 152.

As a result, the charging voltage of the capacitor 154 rises gradually, causing the current flow I of the light emitting diode 157 to decrease. Consequently, the photons emitted from the light emitting diode 157 decrease, thereby causing the output current of the transistor 156 to decrease and the output pulse width of the power control chip 16 to increase. The voltage at the power supply output terminal 17 therefore rises. Voltage charging of the capacitor 154 continues until the diode 153 is reversely biased and cut off. The operation voltage at the first input terminal 11 continues to charge the capacitor 154 via the fifth resistor 152 until the charging voltage reaches +5V.

Since the capacitor 154 of the snubber circuit 15 has to endure a charging voltage of +5V and a large charging current, it is necessary for the capacitor 154 to have large capacity. For example, the capacitor 154 needs to be an electrolytic capacitor. However, an electrolytic capacitor has a big size, and correspondingly makes the snubber circuit 15 quite large. Therefore the switching power supply circuit 10 including the snubber circuit 15 is typically bulky, and not suitable for miniaturized applications in electronic devices.

### SUMMARY

A switching power supply circuit includes at least a power input terminal, a power control chip, and a soft start circuit. The power input terminal is configured for receiving an operating voltage applied to the switching power supply circuit, and the power control chip is configured for modulating a pulse width of an output current of an optical coupler in the soft start circuit to gain a pulse width voltage of the switching power supply circuit. A transistor including a base electrode, a collector electrode and an emitter electrode, such as a triode, is also included in the soft start circuit and is configured to amplify current input thereto. A first resistor, a second resistor, and a capacitor are in the soft start circuit. The base electrode is connected to the power input terminal through the second resistor and the capacitor, the collector electrode is connected to the power input terminal through the optical coupler and the first resistor, and the emitter electrode is grounded.

Since the transistor performs an amplifying function, the current intensity of the capacitor is small, and a voltage level needed for the charging voltage of the capacitor to reach is the cut-off voltage of the transistor rather than the operating voltage. Accordingly, a capacitor can have small capacity. For example, a ceramic capacitor can suffice. Since a ceramic capacitor is small in size compared with an electrolytic capacitor, and the transistor is a multilayer ceramic type that occupies a small volume, the soft start circuit can be made small, and can be suitable for miniaturized applications in electronic devices.

Other novel features and advantages will become more apparent from the following detailed description when taken in conjunction with the accompanying drawings.

### BRIEF DESCRIPTION OF THE DRAWINGS

FIG. 1 is a circuit diagram of a switching power supply circuit according to a preferred embodiment of the prevent invention.

FIG. 2 is a circuit diagram of a conventional switching power supply circuit.

### DETAILED DESCRIPTION OF PREFERRED EMBODIMENTS

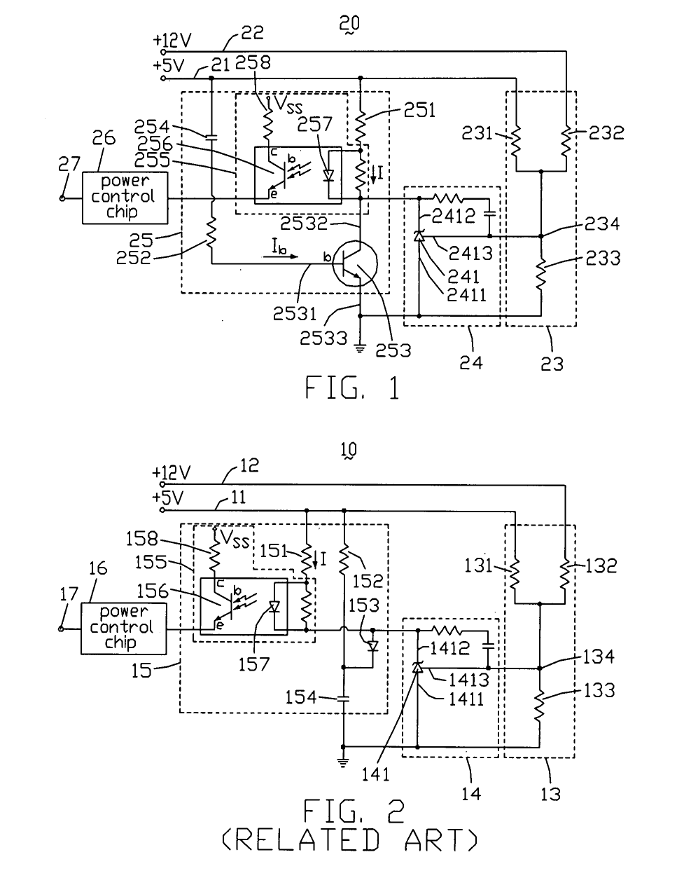

Referring to FIG. 1, a switching power supply circuit 20 of the present invention includes a first input terminal 21, a second input terminal 22, a voltage-dividing unit 23, a voltage-stabilizing unit 24, a soft start unit 25, a power control chip 26, and a power supply output terminal 27. The first input terminal 21 and the second input terminal 22 supply the switching power supply circuit 20 with operating voltages of +5V and +12V respectively. The voltage-dividing unit 23 outputs a divided voltage to the voltage-stabilizing unit 24, and the divided voltage serves as a voltage-stabilizing reference for the voltage-stabilizing unit 24. When a current flow of the soft start unit 25 is so small that an output pulse width voltage of the switching power supply circuit 20 rises beyond a predetermined threshold level, the voltage-stabilizing unit 24 modulates the current flow of the soft start unit 25 such that the output pulse width voltage does not exceed the voltage-stabilizing reference.

The operating voltage of +5V is supplied to the soft start unit 25 and the power control chip 26. An output voltage at the power supply output terminal 27 is supplied to an external load circuit (not shown) via a transformer (not shown).

The voltage-dividing unit 23 includes a first resistor 231, a second resistor 232, and a third resistor 233. The three resistors 231, 232, 233 electrically join together at a voltage-dividing node 234. The +5V operating voltage at the first input terminal 21 is applied across the first resistor 231 and the third resistor 233 and then grounded, while the +12V operating voltage at the second input terminal 22 is applied across the second resistor 232 and the third resistor 233 and then grounded. In this way, a voltage at the voltage-dividing node 234 can be calculated according to Kirchhoff's Law, and the calculated voltage then serves as the voltage-stabilizing reference for the voltage-stabilizing unit 24.

The soft start circuit 25 includes a fourth resistor 251, a fifth resistor 252, a capacitor 254, a triode 253, and an optical coupler 255. The triode 253 includes a base electrode 2531, a collector electrode 2532, and an emitter electrode 2533. The base electrode 2531 is connected with the first input terminal 21 via the fifth resistor 252 and the capacitor 254. The collector electrode 2532 is connected with the first input terminal 21 via the optical coupler 255 and the fourth resistor 251. The emitter electrode 2533 is grounded. The triode 253 is typically a negative-positive-negative (NPN) type triode with a surface mount multilayer ceramic (MLCC) package. Alternatively, the triode 253 can be a positive-negative-positive (PNP) type triode.

The optical coupler 255 includes a transistor 256 and a light emitting diode 257. The transistor 256 includes a base electrode, an emitter electrode, and a collector electrode. The transistor 256 conducts current by employing the base electrode to sense photons emitted from the light emitting diode 257, and by the collector electrode receiving an operation voltage Vss via a current-limiting resistor 258. The power control chip 26 then receives an output current of the optical coupler 255 from the emitter electrode. The power control chip 26 modulates a pulse width of the output current with a sawtooth pulse, such that a pulse width voltage obtained at the power supply output terminal 27 is in inverse proportion to the output current.

The voltage-stabilizing unit 24 includes a three-terminal shunt regulator 241 and an RC series filtering circuit. A so-called TL431 type shunt regulator is usually chosen to be the three-terminal shunt regulator 241. The three-terminal shunt regulator 241 includes an anode 2411, a cathode 2412, and a reference terminal 2413. The cathode 2412 is connected to a terminal of the RC series filtering circuit, and the anode 2411 is grounded. The reference terminal 2413 is connected with another terminal of the RC series filtering circuit and an output of the voltage reference such as the voltage-dividing node 234. When a current flow I of the optical coupler 255 is so small that the output pulse width voltage at the power supply output terminal 27 is excessive, the three-terminal shunt regulator 241 outputs an adjusting voltage at the cathode 2412. The adjusting voltage is then applied to the cathode terminal of the light emitting diode 257, such that the current flow I is adjusted and the output pulse width voltage of the switching power supply circuit 20 does not exceed the voltage-stabilizing reference.

When the switching power supply circuit 20 starts, the +5V operating voltage at the first input terminal 21 begins to charge the capacitor 254. Simultaneously, the triode 253 conducts current and the base electrode current I_{b} of the triode 253 is at a maximum amount.

Thereafter, the charging voltage of the capacitor 254 rises gradually, and the base electrode current I_{b} and the current flow I of the optical coupler 255 decrease correspondingly. Therefore, the photons emitted from the light emitting diode 257 decrease, thus causing the output current at the emitter electrode of the transistor 256 to decrease and the output pulse width of the power control chip 26 to increase. Consequently, the voltage at the power supply output terminal 17 rises. Voltage charging of the capacitor 254 continues until the base electrode current I_{b} diminishes and the diode 153 is reversely biased and cut off. Thus, a soft start for the switching power circuit 20 is completed. The operation voltage at the first input terminal 21 continues to supply the optical coupler 255 via the fourth resistor 251, and an output current of the optical coupler 255 stabilizes the output of the power control chip 26.

Experimental simulations have demonstrated that a soft start process of the switching power supply circuit 20 needs only 0.4 milliseconds when the capacitor 254 has a capacity of 0.1 μF (microfarads).

In summary, the soft start circuit 25 of the switching power supply circuit 20 includes the capacitor 254, a plurality of resistors 251, 252, 258, the optical coupler 255, and the triode 253. Since the triode 253 performs an amplifying function, the current intensity of the capacitor 254 is small, and a threshold voltage level when charging the capacitor 254 is the cut-off voltage of the triode 253 rather than +5V. Accordingly, the capacitor 254 can have a small capacity. For example, a ceramic capacitor can suffice. A ceramic capacitor is small in size compared with an electrolytic capacitor. Further, the triode 253 can be a multilayer ceramic type of triode that occupies a small volume. Thus the soft circuit 25 can be made small, and can be suitable for miniaturized applications in electronic devices.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A switching power supply circuit, comprising:
a first power input terminal configured for receiving a voltage applied to the switching power supply circuit;
a soft start circuit comprising a first resistor, a second resistor, a capacitor, an optical coupler, and a first transistor; and
a power control chip configured for modulating a pulse width of an output current of the optical coupler and outputting a pulse width voltage of the switching power supply circuit;
wherein a base electrode of the first transistor is connected to the first power input terminal through the second resistor and the capacitor, a collector electrode of the first transistor is connected to the first power input terminal through the optical coupler and the first resistor, an emitter electrode of the first transistor is grounded, and the first transistor is configured to amplify current input thereto.

2. The switching power supply circuit as set forth in claim 1, wherein the capacitor is a ceramic capacitor.

3. The switching power supply circuit as set forth in claim 1, wherein the first transistor is a multilayer ceramic transistor.

4. The switching power supply circuit as set forth in claim 3, wherein the first transistor is a negative-positive-negative type triode.

5. The switching power supply circuit as set forth in claim 3, wherein the first transistor is a positive-negative-positive type triode.

6. The switching power supply circuit as set forth in claim 1, wherein the optical coupler comprises a light emitting diode and a second transistor, and the light emitting diode emits photons to conduct current in the second transistor.

7. The switching power supply circuit as set forth in claim 1, wherein the output pulse width voltage is in inverse proportion to the output current of the optical coupler.

8. The switching power supply circuit as set forth in claim 1, wherein the voltage at the first power input terminal is approximately +5V.

9. The switching power supply circuit as set forth in claim 8, further comprising a second power input terminal configured for receiving a voltage of approximately +12V applied to the switching power supply circuit.

10. The switching power supply circuit as set forth in claim 9, further comprising a voltage-dividing unit and a voltage-stabilizing unit, wherein the voltage-dividing unit divides the voltage at the first power input terminal and the second power input terminal and outputs a reference voltage to the voltage-stabilizing unit, and the voltage-stabilizing unit modulates the output current of the optical coupler of the soft start circuit to control the output pulse width voltage of the power control chip such that the output pulse width voltage does not exceed the reference voltage.

11. The switching power supply circuit as set forth in claim 10, wherein the voltage-stabilizing unit comprises a three-terminal shunt regulator and a resistance-capacitance series filtering circuit, the three-terminal shunt regulator comprises a cathode, an anode, and a reference terminal, the cathode is connected to a first terminal of the resistance-capacitance series filtering circuit, the anode is grounded, and the reference terminal is connected to an output of the voltage reference through a second terminal of the resistance-capacitance series filtering circuit.

12. The switching power supply circuit as set forth in claim 11, wherein the three-terminal shunt regulator is a TL431 type shunt regulator.

13. The switching power supply circuit as set forth in claim 10, wherein the voltage-dividing unit comprises a third resistor, a fourth resistor, and a fifth resistor, the voltage at the first power input terminal is grounded through the third resistor and the fifth resistor, and the voltage at the second input terminal is grounded through the fourth resistor and the fifth resistor.

14. A switching power supply circuit, comprising:
a first power input terminal configured for receiving a first voltage applied to the switching power supply circuit;
a second power input terminal configured for receiving a second voltage applied to the switching power supply circuit;
a soft start circuit comprising a first resistor, a second resistor, a capacitor, an optical coupler, and a first transistor; and
a power control chip configured for modulating a pulse width of an output current of the optical coupler and outputting a pulse width voltage of the switching power supply circuit;
wherein a base electrode of the first transistor is connected to the first power input terminal through the second resistor and the capacitor, a collector electrode of the first transistor is connected to the first power input terminal through the optical coupler and the first resistor, an emitter electrode of the first transistor is grounded, and the first transistor is configured to amplify current input thereto.

15. The switching power supply circuit as set forth in claim 14, further comprising a voltage-dividing unit and a voltage-stabilizing unit, wherein the voltage-dividing unit divides the voltage at the first power input terminal and the second power input terminal and outputs a reference voltage to the voltage-stabilizing unit, and the voltage-stabilizing unit modulates an output current of the optical coupler of the soft start circuit to control the output pulse width voltage of the power control chip such that the output pulse width voltage does not exceed the reference voltage.

16. The switching power supply circuit as set forth in claim 15, wherein the voltage-stabilizing unit comprises a three-terminal shunt regulator and a resistance-capacitance series filtering circuit, the three-terminal shunt regulator comprises a cathode, an anode, and a reference terminal, the cathode is connected to a first terminal of the resistance-capacitance series filtering circuit, the anode is grounded, and the reference terminal is connected to an output of the voltage reference through a second terminal of the resistance-capacitance series filtering circuit.

17. The switching power supply circuit as set forth in claim 16, wherein the three-terminal shunt regulator is a TL431 type shunt regulator.

18. The switching power supply circuit as set forth in claim 15, wherein the voltage-dividing unit comprises a third resistor, a fourth resistor, and a fifth resistor, the voltage at the first power input terminal is grounded through the third resistor and the fifth resistor, and the voltage at the second input terminal is grounded through the fourth resistor and the fifth resistor.

19. A method of making switching power supply circuit, comprising steps of:
providing a first power input terminal configured for receiving a voltage applied to the switching power supply circuit;
providing a soft start circuit with a first resistor, a second resistor, a capacitor, an optical coupler, and a first transistor; and
providing a power control chip configured for modulating a pulse width of an output current of the optical coupler and outputting a pulse width voltage of the switching power supply circuit;
wherein a base electrode of the first transistor is connected to the first power input terminal through the second resistor and the capacitor, a collector electrode of the first transistor is connected to the first power input terminal through the optical coupler and the first resistor, an emitter electrode of the first transistor is grounded, and the first transistor is configured to amplify current input thereto.
